(19) United States
(12) Patent Application Publication
(10) Pub. No.: US 2010/0025977 A1
(43) Pub. Date: Feb. 4, 2010

(54) Passenger protection device

(75) Inventor: Hiroshi Tomita, Tokyo (JP)

Correspondence Address: FOLEY AND LARDNER LLP;SUITE 500, 3000 K STREET NW, WASHINGTON, DC, 20007, US

(73) Assignee: Takata corporation

(21) Appl. No.: 12/458,492

(22) Filed: Jul. 14, 2009

(30) Foreign Application Priority Data
Aug. 1, 2008 (JP) 2008-199753

(51) Int. Cl. B60R 22/46

(52) U.S. Cl. 280/806

(57) ABSTRACT

The pretensioner is configured to provide a compact and less expensive pretensioner for improving the work assembly efficiency while effectively transmitting the pressing force of plural force transmission members to the ring gear. Plural balls inside the pipe are pressed under the pressure of gas from the gas generator in an emergency. The first ball presses the lever, and the balls other than the first ball sequentially press the subsequent levers such that the ring gear rotates to move rightward. The internal teeth of the ring gear are meshed with external teeth of the pinion attached to the rotary shaft at the side of the spool. The pinion then rotates to allow the spool to retract the seatbelt. The first ball abuts on the ball stopper portion of the pipe to stop the rest of the balls such that most of the balls are located in the circular movement path.

### BACKGROUND

The present application relates to technical fields of a pretensioner provided for a seatbelt retractor for retracting the seatbelt using plural balls, a seatbelt retractor, and a seatbelt device for a vehicle.

Various types of seatbelt retractors each equipped with the pretensioner have been developed for the seatbelt device installed in the vehicle such as an automobile. The pretensioner is structured to allow reaction gas generated by the gas generator at the early stage in an emergency which applies higher deceleration than the one in the normal state to the vehicle involved with the collision to rotate the spool of the seatbelt retractor in the seatbelt retracting direction so as to retract the seatbelt with the spool. This makes it possible to take up the loosening of the seatbelt immediately, and to apply the tension force to the seatbelt for enhancing the force to restrain the occupant.

The pretensioner structured to store plural force transmission members each formed as a ball inside the pipe, which move therethrough under the pressure of the reaction gas generated in the emergency to press the plural pressure receiving portions of the ring gear for rotating the spool in the seatbelt retracting direction has been well known as an example of the generally employed pretensioner (for example, Japanese Unexamined Patent Application Publication No. 2001-233172, and Japanese Unexamined Patent Application Publication No. 2005-306111).

The pretensioner structured to store plural force transmission members formed as balls in the pipe, which move therethrough under the pressure of the reaction gas in the emergency to press one pressure receiving portion of the ring gear for rotating the spool in the seatbelt retracting direction is also well known (for example, see UK Patent Application GB 2323016A, incorporated by reference herein).

In the pretensioner disclosed in Japanese Unexamined Patent Application Publication No. 2001-233172, and Japanese Unexamined Patent Application Publication No. 2005-306111 (both incorporated by reference herein), after a ball has engaged and rotated the ring gear, it is released from the notch portion of the pipe to move away from the ring gear so as to be stored in the ball storage chamber specially formed in the pretensioner. The ball storage chamber may increase the pretensioner size, and accordingly, further increase the seatbelt retractor size.

As the balls are stored in the ball storage chamber, the number of the balls is relatively large. The length of the pipe as the expensive component is increased. As a result, cost for the generally employed pretensioner becomes high. Besides, as the pipe has to be elongated to a certain length, the gas generator is inevitably disposed below the seatbelt retractor, which makes the work for assembling the gas generator complicated. If the gas generator is intended to be forcedly disposed above the seatbelt retractor, the piping becomes difficult, thus increasing the seatbelt retractor size.

Meanwhile, in the pretensioner disclosed in UK Patent Application GB 2323016A, plural balls move along the movement path formed around the outer circumference of the ring gear while pressing the single pressure receiving portion. Those balls stop in the movement path as the ring gear stops rotating. The structure requires no specific ball storage chamber.

The combination of the pretensioner disclosed in Japanese Unexamined Patent Application Publication No. 2001-233172, and Japanese Unexamined Patent Application Publication No. 2005-306111 with the pretensioner disclosed in UK Patent Application GB 2323016A may be considered for eliminating the specific ball storage chamber.

In the pretensioner disclosed in UK Patent Application GB 2323016A, the ring gear has only one pressure receiving portion to which the plural balls apply pressing force. The pressing force of the plural balls cannot be transmitted to the ring gear effectively. The aforementioned structure fails to effectively retract the seatbelt while the pretensioner is operated. As the ring gear has external teeth with which the pinion is meshed, the rotating amount of the ring gear while pretension is operated cannot be set to the large value. As the ring gear is meshed with the pinion via the external teeth, the plural pressure receiving portions cannot be formed on the outer circumference of the ring gear. It is therefore difficult to effectively combine the pretensioner disclosed in Patent Document 3 with the pretensioner disclosed in Japanese Unexamined Patent Application Publication No. 2001-233172, and Japanese Unexamined Patent Application Publication No. 2005-306111.

Accordingly, an object of the embodiments described below is to provide a pretensioner which improves the assembly work efficiency while effectively transmitting the pressing force of the plural force transmission members to the ring gear so as to be formed as a compact structure at low costs, a seatbelt retractor provided with the pretensioner, and a seatbelt device provided with the seatbelt retractor.

### SUMMARY

One embodiment relates to a pretensioner comprising a pipe; plural force transmission members movably disposed in the pipe for transmitting a force for rotating a spool in a seatbelt retracting direction; and a gas generator which generates gas in an emergency. The pretensioner further comprises a ring gear disposed at least rotatably, the ring gear having plural internal teeth on an inner circumference and plural pressure receiving portions on an outer circumference. The pretensioner further comprises a pinion disposed on a spool side member, having external teeth meshed with the internal teeth for rotating the spool. The force transmission member presses the pressure receiving portion of the ring gear to rotate the spool in the seatbelt retracting direction at a force transmission portion formed in the pipe in the emergency, the pretensioner comprising a movement path formed to have a circular shape concentric with a rotating center of the pinion, through which the force transmission member is movable, wherein the force transmission member is allowed to be located in the movement path at the end of an operation.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 schematically shows a seatbelt device having a seatbelt retractor as an example.

FIG. 2 shows the seatbelt retractor, wherein (a) is a view seen from outside the vehicle, (b) is a left side view, (c) is a right side view, and (d) is a top view.

FIG. 3 is a left side view of the seatbelt retractor shown in FIG. 2 having the pretensioner cover removed.

FIG. 4(a) is a partially cross section taken along line IVA-IVA shown in FIG. 3, (b) is a partially cross section of the modified example in the same way as in (a), and (c) is a partially cross section of another modified example in the same way as in (a).

FIG. 5 shows the pretensioner cover, wherein (a) is a top view, (b) is a front view, and (c) is a bottom view.

FIG. 6 shows the operation of the pretensioner, wherein (a) is a view showing the state in operation, (b) is a view showing the state immediately after starting the operation, and (c) is a view showing the state at the end of the operation.

### DETAILED DESCRIPTION

According to an exemplary embodiment, a seatbelt device is provided for a vehicle including at least a seatbelt retractor for retracting the seatbelt, a tongue slidably supported with a seatbelt, and a buckle attached to a vehicle body, with which the tongue is detachably engaged. The seat retractor includes at least a seatbelt, a spool for retracting the seatbelt, and a pretensioner for rotating the spool in a seatbelt retracting direction in an emergency.

According to an exemplary embodiment, a pretensioner includes a pipe, multiple force transmission members movably disposed in the pipe for transmitting a force for rotating a spool in a seatbelt retracting direction, and a gas generator which generates gas in an emergency. The pretensioner further includes a force transmission member stopper on which a first one of the plural force transmission members abuts to stop movement of the force transmission members. The force transmission member stopper may be formed as a component of the pretensioner, such as a pipe around the force transmission portion. If the pretensioner is provided with a case, the force transmission member stopper may be formed as a protrusion of the case.

The pretensioner further includes a ring gear disposed at least rotatably, having plural internal teeth on an inner circumference and plural pressure receiving portions on an outer circumference. The pretensioner still further includes a pinion disposed on a spool side member, having external teeth meshed with the internal teeth for rotating the spool. According to an exemplary embodiment, the spool side member and the pinion are integrally formed as a single member.

The force transmission member presses the pressure receiving portion of the ring gear to rotate the spool in the seatbelt retracting direction at a force transmission portion formed in the pipe in the emergency. The pretensioner further includes a movement path formed to have a circular shape concentric with a rotating center of the pinion, through which the force transmission member is movable. The force transmission member is allowed to be located in the movement path at the end of an operation.

In the above-structured pretensioner and the seatbelt retractor, the external teeth of the pinion formed on the spool side member are meshed with the internal teeth of the ring gear, and the force transmission members which sequentially move inside the pipe and rotate the ring gear by pressing against the plural pressure receiving portions of the ring gear. The spool is then rotated to retract the seatbelt. After engaging the pressure receiving portions of the ring gear, the force transmission member is stored in the circular movement path concentric with the pinion. Therefore, unlike conventional pretensioners, the disclosed pretensioner does not require a chamber for storing the force transmission members. This makes it possible to efficiently use the force of the plural force transmission members to rotate the ring gear while forming the pretensioner into a compact structure.

The first force transmission member abuts on the force transmission member stopper which is formed of the component of the pretensioner, thus stopping the plural force transmission members effectively. In such a case, the force transmission member stopper is formed of the component of the pretensioner to eliminate the need of separate force transmission member stopper, thus reducing the cost of the pretensioner.

The force transmission member stopper is disposed around the force transmission portion of the pipe, and allows approximately one rotation of the ring gear. This makes it possible to increase the seatbelt retracting amount of the spool. In the aforementioned case, the gear ratio between the internal teeth of the ring gear and the external teeth of the pinion is set as needed to efficiently retract the seatbelt by approximately one rotation of the ring gear.

As the ring gear is allowed to make approximately one rotation, the number of the force transmission members may be reduced. This makes it possible to efficiently reduce the length of the pipe. As the pipe may be formed from a relatively expensive material, this effectively reduces the cost of the pretensioner.

The pipe may have the leading end located at the lowermost position (i.e. proximate to the ring gear) and extends linearly upward from the leading end. The pipe is bent at a substantially right angle at the upper end of the frame base to linearly extend toward the vehicle exterior side in a substantially horizontal direction. The pipe is further bent at a substantially right angle at the end of the base at the vehicle exterior side so as to extend along the longitudinal direction of the vehicle. It is still further bent at a substantially right angle at the end of the base along the longitudinal direction of the vehicle so as to extend slightly upward with respect to the horizontal direction toward the vehicle interior side. The shape of the pipe makes it possible to direct the open end of the pressure vessel and the gas generator slightly upward at the vehicle interior side. The aforementioned piping further simplifies the insertion of the force transmission members into the pipe and the work for assembling the gas generator with the pressure vessel. The piping allows the seatbelt retractor with the pretensioner to have a more compact structure.

The spool side member and the pinion may be integrally formed as a single member. In such a case, the pinion may further be made compact by forging. This makes it possible to increase the gear ratio between the ring gear and the pinion accordingly. Even if the number of the force transmission members is reduced, the rotating amount of the spool performed by the pretensioner may be increased. As a result, the seatbelt retracting amount may be effectively increased while reducing the pipe length.

By reducing the size of the seatbelt retractor, the space needed in the vehicle for the seatbelt device may be reduced. This allows a greater degree of freedom in the placement of the seatbelt retractor on the vehicle body. The seatbelt retractor may be installed in the vehicle body flexibly, improving convenience of the seatbelt device.

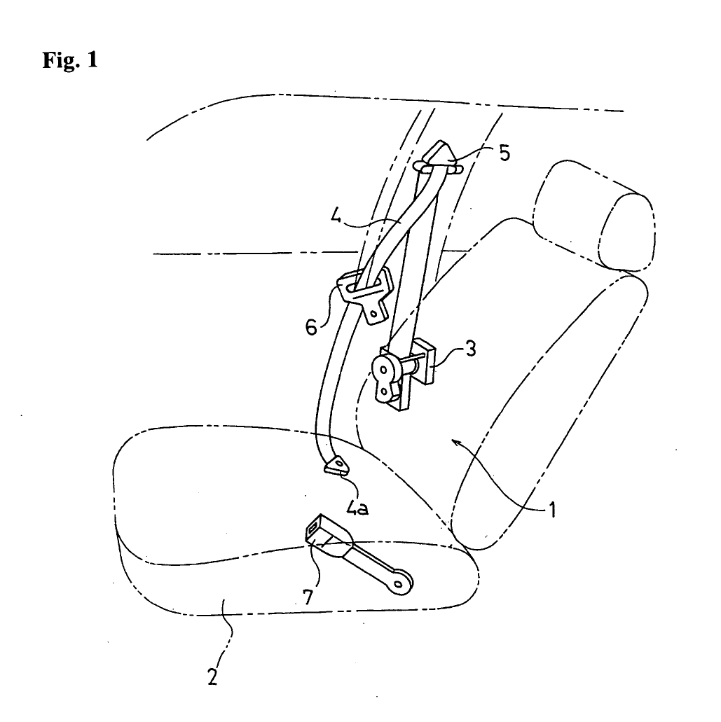

Referring to FIG. 1, according to an exemplary embodiment, a seatbelt device 1 is similar to the known three-point seatbelt device but is configured to be more compact and therefore more easily placed in the interior of a vehicle. As shown in FIG. 1, the seatbelt device 1 is provided proximate to a vehicle seat 2. The seatbelt device 1 includes a seatbelt retractor 3 disposed around the vehicle seat 2, a seatbelt 4 which can be retracted and withdrawn by the seatbelt retractor 3, a belt anchor 4a at the leading end of the seatbelt 4 that is fixed to the floor of the vehicle body or the vehicle seat 2, a guide anchor 5 which guides the seatbelt 4 withdrawn from the seatbelt retractor 3 toward the occupant's shoulder, a tongue 6 slidably supported at the seat belt 4 guided by the guide anchor 5, and a buckle 7 fixed to the floor of the vehicle or the vehicle seat, into which the tongue 6 is inserted so as to be engaged therewith or disengaged therefrom.

The fastening and unfastening operations of the seatbelt 4 of the seatbelt device 1 are the same as those in the generally known and employed seatbelt device.

The seatbelt retractor 3 of the example may be a known emergency lock type belt retractor (ELR) or a known automatic lock type seatbelt retractor (ALR), which is provided with the pretensioner. Likewise the known pretensioner, it is activated upon application of the deceleration considerably higher than the one during the normal running to the vehicle involved in the collision for rotating the spool of the seatbelt retractor 3 in the seatbelt retracting direction. The seatbelt 4 is retracted by a certain amount for enhancing the force for restraining the occupant.

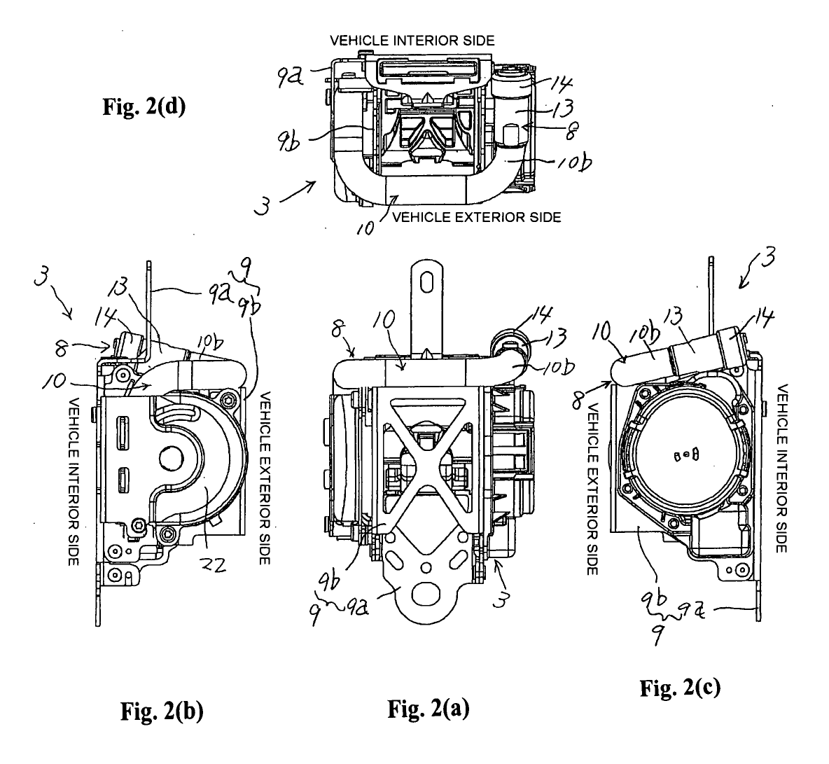

Referring to FIGS. 2(a) to 2(d), an exemplary pretensioner 8 is supported at a frame 9 of the seatbelt retractor 3. The frame 9 is formed of a stay 9a disposed at the vehicle interior side and a U-like shaped base portion 9b disposed at the vehicle exterior side upon installation of the seatbelt retractor 3 in the vehicle body. The stay 9a is detachably attached to the vehicle body, and the base portion 9b is detachably attached to the stay 9a. Components of the seatbelt retractor 3 such as the spool and the lock mechanism are attached to the base portion 9b. As the frame 9 is formed of the stay 9a and the base portion 9b which are separated, the stay 9a may be a common designed used for a wide variety of seatbelt retractors. The base portion may only be changed in accordance with the type of the seatbelt retractor 3. This makes it possible to flexibly install the seatbelt retractor 3 of the type in accordance with the vehicle model.

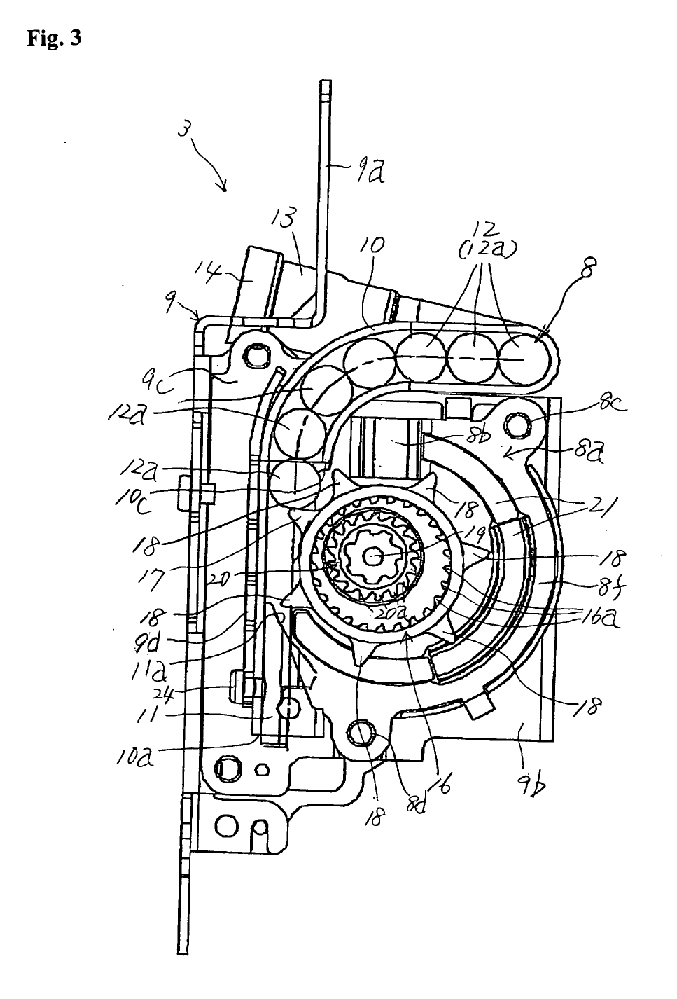

Referring to FIG. 3, the pretensioner 8 includes a pipe 10 having a leading end 10a closed with a sealing plug 11. The leading end 10a of the pipe 10 and the sealing plug 11 are fixed to a pipe attachment portion 9d formed on a side wall 9c of the base portion 9b with a fastener 24 such as a bolt.

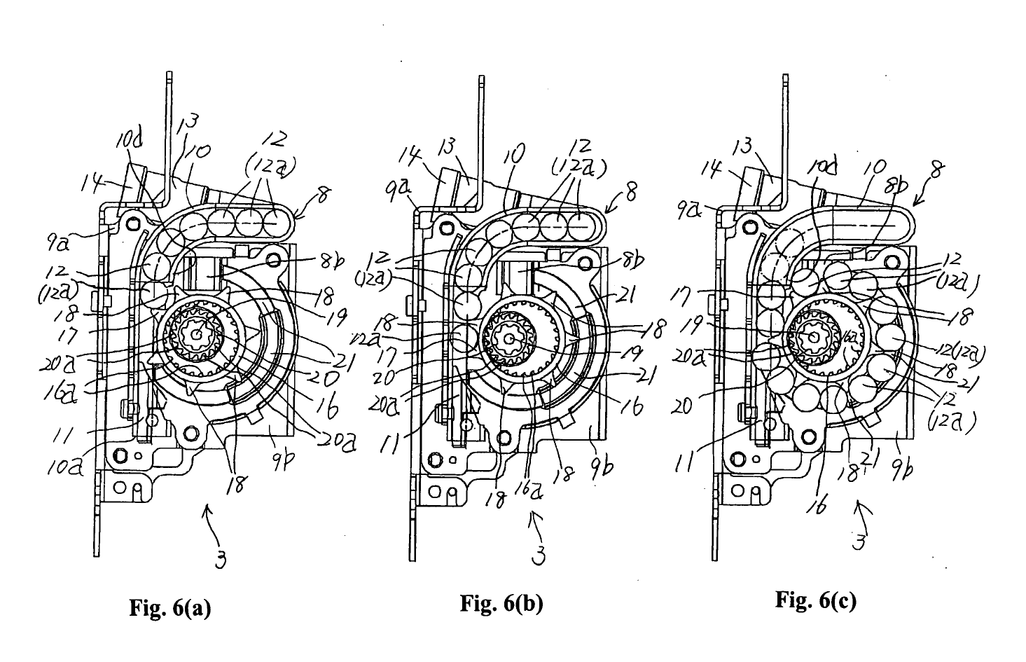

Multiple force transmission members 12 which include plural metal balls 12a each formed of a relatively hard material (e.g., a metal such as iron or aluminum), and a piston (not shown) for pressing the balls 12a under the gas pressure are disposed inside the pipe 10 so as to be movable in contact with each other. The number of the balls 12a of the pretensioner 8 in the example is smaller than that of conventional pretensioners (for example, the number of the balls of the pretensioner in the example is set to 13 as shown in FIG. 6(c) compared with 16 balls of a conventional pretensioner). The pipe-like pressure vessel 13 is connected to a proximal end 10b of the pipe 10. The pressure vessel 13 has a gas generator 14.

The pretensioner 8 includes a case 8a attached to the side wall 9c. A ring gear 16 is disposed inside the case 8a so as to be rotatable and movable rightward as shown in FIG. 3. The ring gear 16 includes plural internal teeth 16a formed on an inner circumferential surface, and has a portion which is allowed to be inserted into the pipe 10 from a notch portion 10c at the leading end thereof.

The ring gear 16 is provided with a lever or pressure receiving portion 17 on which a first ball 12a abuts in the normal state (pretensioner 8 is inactive), and plural (six in the drawing) levers 18 which protrude on the outer circumferential surface. In this case, the circumferential interval between the first lever 17 and the adjacent lever 18 is set so as to partially accommodate the single ball 12a. The plural levers 18 are arranged such that the circumferential interval therebetween is set to partially accommodate two adjacent balls 12a in contact with each other.

A pinion 20 is rotatably and integrally attached to a rotary shaft or spool side member 19 of the locking base for the seatbelt retractor 3. The pinion 20 may be rotatably and integrally attached to the not shown rotary shaft of the spool. The locking base is provided for the known ELR and ALR, which rotates integrally with the spool of the seatbelt retractor 3 for retracting the seatbelt 4 in the normal state. In an emergency where the high deceleration is applied to the vehicle involved in the collision, the rotating operation is locked to activate the lock mechanism to prevent the spool from rotating in the seatbelt retracting direction. The ELR provided with the pretensioner which uses plural balls and the locking base is disclosed in Japanese Unexamined Patent Application Publication No. 2001-233172, as described above and the detailed description thereof will therefore be omitted.

The pinion 20 includes a plurality of external teeth 20a which may be meshed with the internal teeth 16a of the ring gear 16. In this case, the diameter of the addendum circle of the pinion 20 of the exemplary pretensioner 8 is smaller than the diameter of the addendum circle of the pinion in a conventional pretensioner (for example, the addendum diameter of the pinion one conventional pretensioner is 24.6 mm compared with the addendum diameter of the pinion 20 of the exemplary pretensioner 8 set to 19 mm). During the operation of the pretensioner 8, the balls 12a apply a force to the levers 17 and 18 to rotate the ring gear 16. The levers 17 and 18 enter into the pipe 10 from the notch portion 10c while applying the direct moving force to the ring gear 16 toward the pinion 20. The notch portion 10c of the pipe 10 serves as the force transmission portion where the force transmission members 12 as the balls 12a transmit the rotating drive force and the direct moving force to the ring gear 16.

The leading end 10a of the pipe 10 is located at the lowermost position when the pretensioner 8 is installed in the vehicle body. The pipe linearly extends from the leading end 10a upward such that the force transmission portion of the notch portion 10c is in a substantially horizontal orientation with respect to the rotating center point of the pinion 20 (that is, spool). Each of the balls 12a contacts the ring gear 16 tangentially to transmit the force to the ring gear 16 and rotate the ring gear 16 in the seatbelt retracting direction. As a result, the balls 12a are capable of transmitting the force to the ring gear 16 most efficiently.

The pipe 10 is bent at a substantially right angle around the upper end of the base portion 9b of the frame 9 to linearly extend toward the vehicle exterior side in a substantially horizontal direction. It is further bent at a substantially right angle at a portion around the end opposite the stay 9a of the base portion 9b to linearly extend in a substantially horizontal direction along the longitudinal direction of the vehicle. It is still further bent at a substantially right angle around the portion at the end of the base portion 9b along the longitudinal direction of the vehicle to linearly extend toward the vehicle interior side while being tilted slightly upward with respect to the horizontal direction. Accordingly, the pressure vessel 13 and the gas generator 14 are directed slightly upward above the base portion 9b toward the vehicle interior side.

The case 8a includes a guide groove 21 for guiding the balls 12a. The guide groove 21 is formed to have a circular shape concentric with the center of the ring gear 16 when the ring gear 16 is moved rightward so the internal teeth 16a mesh with the external teeth 20a of the pinion 20. An end of the sealing plug 11 inside the pipe at a joint portion between the guide groove 21 and the pipe 10 forms a circular guide surface 11a for smoothly guiding the ball 12a from the pipe 10 to the guide groove 21. In this case, the diameter of the arc on the guide surface 11a is substantially the same as the diameter of the outer diameter side of the guide groove 21.

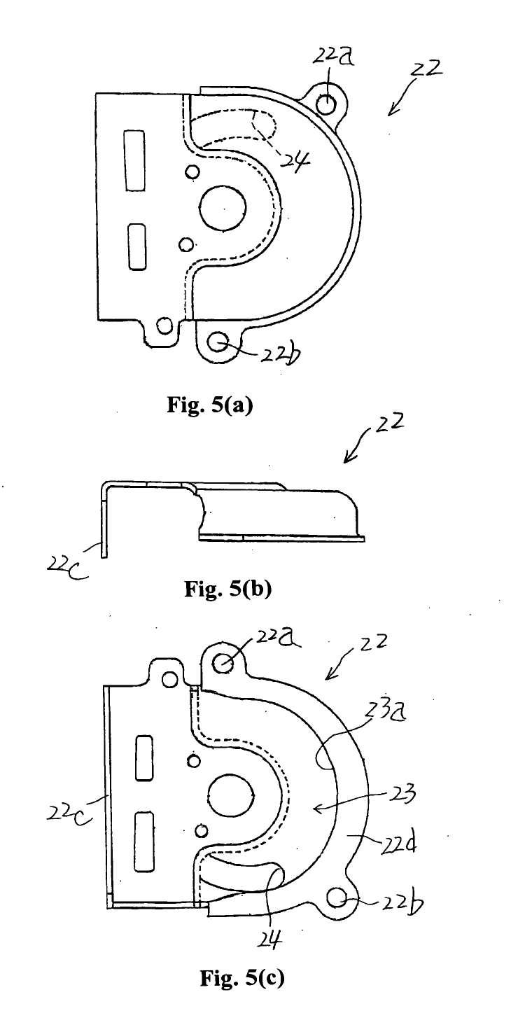

The case 8a is partially covered with a cover. Referring to FIGS. 5(a) to 5(c), the cover 22 includes attachment portions 22a, 22b attached to two cover attachments 8c, 8d of the case 8a, and an engagement portion 22c to be engaged with a pipe attachment portion 9d of the side wall 9c. When a joining surface 22d shown in FIG. 5(c) is joined with a joining surface 8f (shown in FIG. 3) of the case 8a, and the engagement portion 22c is engaged with the pipe attachment portion 9d, the bolts are inserted into the bolt insertion holes of the attachment portions 22a, 22b threaded with the internal threads of the cover attachments 8c, 8d such that the cover 22 is attached to the case 8a. With the cover 22 attached to the case 8a, the movement path through which the balls 12a move is formed between the case 8a and the cover 22. The circular movement path is formed into the arc concentric with the pinion 20.

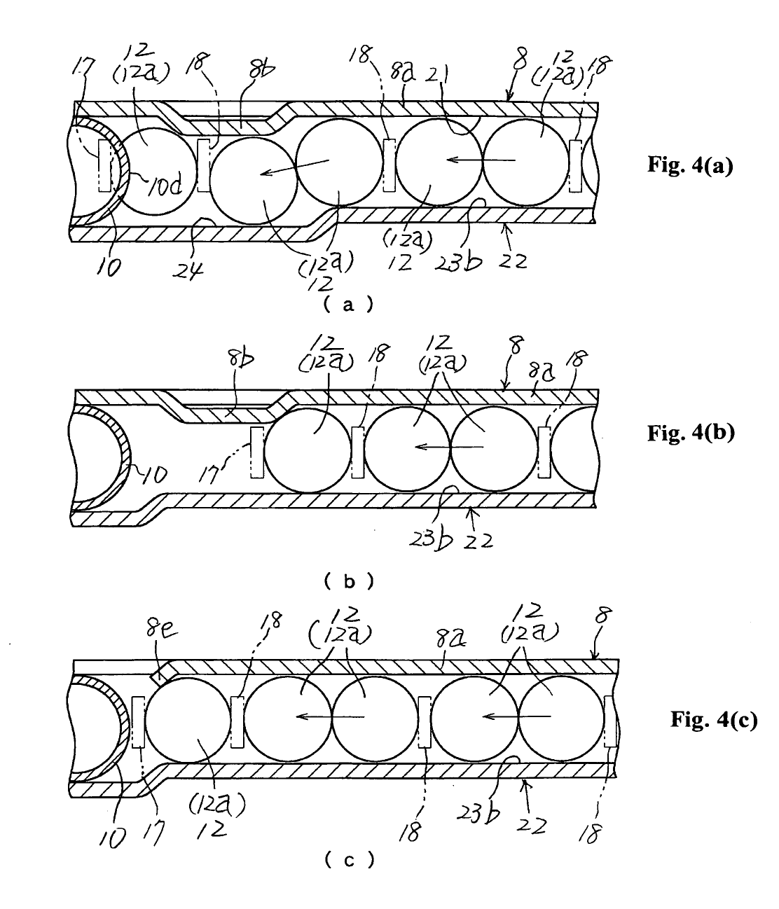

Referring to FIG. 5(c), the cover 22 has a relatively large circular recess portion 23 along which the ball 12a is movable. The recess portion 23 is substantially semicircular having an inner peripheral wall surface 23a at the outer circumferential side as a guide surface for guiding the ball 12a along the recess portion 23. Referring to FIGS. 5(a) and 5(c), a circular guide groove 24 is formed at the terminal end of the recess portion 23 (the upper end side of the recess portion 23 shown in FIG. 5(a)). When the cover 22 is attached to the case 8a, the guide groove 24 is directed opposite the protrusion 8b of the case 8a as shown in FIG. 4(a). The guide groove 24 extends to the portion near the pipe 10.

The movement path for the ball 12a is defined by the case 8a and the cover 22. The movement path extends to the portion near the pipe 10 across the protrusion 8b. The ball 12a moving through the pipe 10 is guided on the guide surface 11a of the sealing plug 11 to enter into the movement path between the case 8a and the cover 22 from the notch portion 10c of the pipe 10, and is allowed to move along the movement path. In the aforementioned case, the ball 12a moves through the movement path while being guided by the guide groove 21, the inner circumferential wall surface 23a of the recess portion 23, the bottom surface 23b of the recess portion 23 (surface opposite the case 8a), the protrusion 8b, and the guide groove 24. As the first ball 12a abuts on the pipe 10 around the notch portion 10c, the subsequent balls 12a stop moving as described later. The ball abutment portion of the pipe 10 serves as a ball stopper portion 10d.

The operation of the pretensioner 8 is similar to a conventional pretensioner which uses a plurality of balls, that is, it is activated in an emergency of high deceleration applied to the vehicle involved in the collision for rotating the spool of the seatbelt retractor 3 in the seatbelt retracting direction.

Referring to FIG. 6(a), when the pretensioner 8 is in the non-active state, the first ball 12a contacts the lever 17, and the subsequent adjacent balls 12a are contact each other. In the aforementioned state, the gas generator 14 does not generate gas, and accordingly, the ball 12a applies substantially no pressure to the lever 17. The internal teeth 16a of the ring gear 16 are kept disengaged from the external teeth 20a of the pinion 20.

In the emergency as described above, the gas generator 14 is activated to generate gas to apply the large pressing force to the balls 12a. Then the ring gear 16 is moved under the pressing force via the first ball 12a as shown in FIG. 6(a) and is turned counterclockwise. Referring to FIG. 6(b), the internal teeth 16a of the ring gear 16 are meshed with the external teeth 20a of the pinion 20. The pinion 20 starts turning in the same direction as the ring gear 16. The rotary shaft 19, that is, the spool, starts rotating in the seatbelt retracting direction and begins to retract the seatbelt 4 which restrains the occupant.

The first ball 12a is held between the levers 17 and 18. When the second ball 12a contacts or abuts the lever 18 adjacent to the lever 17 clockwise, the ring gear 16 and the pinion 20 are further turned counterclockwise under the pressing force of the lever 18 via the second ball 12a. The pressing force of the first ball 12a applied to the lever 17 is therefore substantially lost once the second ball 12a applies pressure to the lever 18. The second and the third balls 12a are held between the lever 18 and the next lever 18 adjacent thereto clockwise. When the fourth ball 12a next to the third ball 12a abuts on the next lever 18, the pressing force to the subsequent lever 18 via the fourth ball 12a further turns the ring gear 16 and the pinion 20 together counterclockwise. When the fourth ball 12a engages the lever 18, the pressing force of the second and the third balls 12a applied to the lever 18 is substantially lost.

The operation of the pretensioner 8 to the stage so far is substantially the same as a conventional pretensioner. In the conventional pretensioner, once a ball ceases to provide a pressing force to the lever (i.e., once the following ball has engaged the lever), the ball moves out from the notch portion of the pipe away from the lever and is stored in the ball storage chamber formed in the pretensioner. Meanwhile, the exemplary pretensioner 8 shown in FIGS. 2-6c has no ball storage chamber. Instead, the first to the third balls 12a each no longer providing a substantial pressing force to the levers 17, 18 are guided on the circular guide surface 11a of the sealing plug 11 to move away from the notch portion 10c of the pipe 10, and further move into the circular movement path formed between the case 8a and the cover 22.

The pressing force of the fourth and subsequent balls 12a to the adjacent levers 18 sequentially arranged clockwise rotates the ring gear 16 and the pinion 20 together counterclockwise continuously. Referring to FIG. 6(c), the ball 12a which moves to the movement path and no longer provides a substantial pressing force is moved along the movement path by the levers 17 and 18 of the ring gear 16 accompanied with the rotation thereof. Referring to FIG. 4(a), when the ball 12a reaches the protrusion 8b, it is pressed by the protrusion 8b against the cover 22. As the cover 22 has the guide groove 24 opposite the protrusion 8b, the ball 12a pressed by the protrusion 8b moves into the guide groove 24 while climbing over the protrusion 8b. The trapezoidal shape of the protrusion 8b allows the ball 12a to smoothly climb over the tilted surface of the side wall of the trapezoidal shape. Referring to FIGS. 4(a) and 6(c), when the first ball 12a which has climbed over the protrusion 8b abuts on the ball stopper portion 10d of the pipe 10, the first ball 12a stops, and the rotation of the ring gear 6 stops as well. The pinion 20 also stops rotating to finish retraction of the seatbelt 4 by the spool. The retraction of the seatbelt 4 by the pretensioner 8 further enhances its force for restraining the occupant.

As the ring gear 6 stops rotating, the second and subsequent balls 12a stop moving. At this moment, the pressure of the gas generated in the pipe 10 is low. In the state where the balls 12a are stationary, most of those balls 12a are located in the movement path between the case 8a and the cover 22. That is, most of the balls 12a are located in the movement path at the end of operation of the pretensioner 8.

The other operation of the pretensioner 8 of the example is substantially the same as a conventional pretensioner using a plurality of balls. The other operation of the seatbelt retractor 3 is substantially the same as the known ELR or ALR.

In the pretensioner 8 according to the example, the balls 12a apply the pressing force to the plural levers 16a of the ring gear 16 sequentially. The resultant rotation of the ring gear 16 further rotates the spool to retract the seatbelt 4. The ball 12a no longer providing a rotating force for the ring gear 16 is stored in the circular movement path between the case 8a of the pretensioner 8 and the cover 22. Unlike a conventional pretensioner, the ball storage chamber is not required. This makes it possible to make the pretensioner 8 compact while efficiently utilizing the force of the plural balls for rotating the ring gear 16.

The first ball 12a is allowed to contact the force transmission member stopper formed as the pipe 10 which constitutes the pretensioner 8 to effectively stop the plurality of balls 12a after the first ball 12a. In such a case, the force transmission member stopper is formed as the component of the pretensioner 8 to eliminate the need of a separate force transmission member stopper, resulting in cost reduction.

As the first ball 12a is stopped at the ball stopper portion 10d located around the force transmission portion of the notch portion 10c of the pipe 10, the ring gear 16 is allowed to make substantially one rotation. This makes it possible to set the large seatbelt retracting amount performed by the spool. Especially, the gear ratio between the internal teeth 1 6a of the ring gear 16 and the external teeth 20a of the pinion 20 is set to the appropriate value to effectively retract the seatbelt by substantially one rotation of the ring gear 16.

As the ring gear 16 is allowed to make substantially one rotation, the number of the balls 12a may be reduced. This makes it possible to effectively reduce the length of the pipe 10, thus effectively reducing the amount of material needed and the cost.

As the length of the pipe 10 is reduced, the pipe 10 may be bent and formed such that the leading end 10a of the pipe 10 is located at the lowermost position.

The pipe linearly extends from the leading end 10a upward such that the force transmission portion of the notch portion 10c is in a substantially horizontal orientation with respect to the rotating center point of the pinion 20 (that is, spool). Each of the balls 12a contacts the ring gear 16 tangentially to transmit the force to the ring gear 16 and rotate the ring gear 16 in the seatbelt retracting direction. As a result, the balls 12a are capable of transmitting the force to the ring gear 16 most efficiently.

In the piping, the pipe linearly extends from the leading end 10a upward, and is bent at a substantially right angle at the upper end of the base portion 9b of the frame 9 to linearly extend toward the vehicle exterior side in a substantially horizontal direction. It is further bent at a substantially right angle at a portion around the end opposite the stay 9a of the base portion 9b to linearly extend in a substantially horizontal direction along the longitudinal direction of the vehicle. It is still further bent at a substantially right angle around the portion at the end of the base portion 9b along the longitudinal direction of the vehicle to linearly extend toward the vehicle interior side while being tilted slightly upward with respect to the horizontal direction. This makes it possible to direct the opening end of the pressure vessel 13 and the gas generator 14 slightly upward at the vehicle interior side. As a result, the work for inserting the balls 12a into the pipe 10 and the work for assembling the gas generator 14 with the pressure vessel 13 may be conducted more easily. The piping of the pipe 10 allows the seatbelt retractor 3 with the pretensioner 8 to be made more compact as a whole.

By making the seatbelt retractor 3 more compact, it possible to reduce the space of vehicle body for accommodating the seatbelt retractor 3. The degree of freedom for installing the seatbelt retractor 3 in the vehicle body may be increased. The increased flexibility in locations for installing the seatbelt retractor 3 in the vehicle body may further improve the convenience of the seatbelt device 1.

In the aforementioned example, the ball stopper portion 10d is disposed around the force transmission portion of the notch portion 10c of the pipe 10. Referring to FIG. 4(b), the ball stopper portion may be formed as the protrusion 8b of the case 8a which constitutes the pretensioner 8. Referring to FIG. 4(c), the ball stopper portion may be formed as a specific protrusion 8e formed on the case 8a.

The seatbelt retractor may be designed into various forms without being limited to the aforementioned example. In the example of the embodiment, the pinion 20 is formed separately from the rotary shaft 19 of the locking base, and attached thereto so as to be integrally rotatable. The pinion 20 may be integrally formed with the locking base using the single member. In such a case, the pinion 20 may be forged to have a reduced size. The gear ratio between the ring gear 16 and the pinion 20 may be set to be larger by the amount corresponding to the size reduction. The pretensioner may be configured to rotate the spool an increased amount even if the number of the balls 12a is reduced. This makes it possible to effectively increase the retracting amount of the seatbelt 4 while reducing the length of the pipe 10.

The present pretensioner may be designed into various forms without departing from the scope of the claims. The pretensioner, the seatbelt retractor and the seatbelt device may be preferably applied to the pretensioner provided for the seatbelt retractor for retracting the seatbelt using plural balls, the seatbelt retractor, and the seatbelt device for the vehicle, respectively.

The priority application, Japanese Application No. 2008-199753, filed Aug. 1, 2008 is incorporated herein by reference in its entirety.

Given the disclosure of the application, one versed in the art would appreciate that there may be other embodiments and modifications within the scope and spirit of the application. Accordingly, all modifications attainable by one versed in the art from the present disclosure within the scope and spirit of the present application are to be included as further embodiments of the present application.

What is claimed is:

1. A pretensioner for use with a vehicle seat belt retractor comprising:
a pipe;
plural force transmission members movably disposed in the pipe for transmitting a force for rotating a spool in a seatbelt retracting direction;
a gas generator which generates gas in the case of an emergency involving the vehicle;
a ring gear rotatably disposed, having plurality of internal teeth on an inner circumference and plural pressure receiving portions on an outer circumference; and
a pinion disposed on a spool side member, having external teeth meshed with the internal teeth for rotating the spool;
wherein the pretensioner is configured so that the force transmission member presses the pressure receiving portion of the ring gear to rotate the spool in the seatbelt retracting direction at a force transmission portion formed in the pipe in the emergency;
wherein the pretensioner is configured so that the force transmission member is movable through a movement path formed to have a circular shape concentric with a rotating center of the pinion; and
wherein the force transmission member may be located in the movement path at the end of an operation.

2. The pretensioner of claim 1, further comprising a force transmission member stopper on which a first one of the plural force transmission members abuts to stop movement of the force transmission members.

3. The pretensioner of claim 2, wherein the force transmission member stopper is a component of the pretensioner.

4. The pretensioner of claim 3, wherein a portion of the pipe around the force transmission portion is a component of the pretensioner.

5. The pretensioner of claim 3, further comprising a case, wherein a protrusion of the case is a component of the pretensioner.

6. The pretensioner of claim 1, wherein the spool side member and the pinion are integrally formed of a single member.

7. The pretensioner of claim 1, wherein the pipe is attached to a frame of a seatbelt retractor, and extends so that a leading end of the pipe is located at a lowermost position to extend from the leading end linearly upward, the pipe is bent at a substantially right angle at an upper end of a base portion of the frame to linearly extend in a substantially horizontal direction toward a vehicle exterior side, bent at a substantially right angle of an end of the base portion at the vehicle exterior side along a longitudinal direction of the vehicle, and bent at a substantially right angle of the base portion at an end of the base portion along the longitudinal direction of the vehicle to extend toward the vehicle interior side.

8. A seatbelt retractor comprising:
a spool for retracting a seatbelt, and a pretensioner for rotating the spool in a seatbelt retracting direction in an emergency, wherein the pretensioner comprises:
a pipe;
a plurality of force transmission members movably disposed in the pipe for transmitting a force for rotating a spool in a seatbelt retracting direction;
a gas generator which generates gas in the case of an emergency involving the vehicle;
a ring gear rotatably disposed, having plurality of internal teeth on an inner circumference and plural pressure receiving portions on an outer circumference; and
a pinion disposed on a spool side member, having external teeth meshed with the internal teeth for rotating the spool;
wherein the pretensioner is configured so that the force transmission member presses the pressure receiving portion of the ring gear to rotate the spool in the seatbelt retracting direction at a force transmission portion formed in the pipe in the emergency;
wherein the pretensioner is configured so that the force transmission member is movable through a movement path formed to have a circular shape concentric with a rotating center of the pinion; and
wherein one of the force transmission members may be located in the movement path at the end of an operation.

9. A seatbelt system comprising:
a seat belt;
a seatbelt retractor for retracting the seatbelt;
a tongue slidably supported by the seatbelt; and
a buckle attached to a vehicle body, with which the tongue is detachably engaged, wherein the seatbelt retractor comprises:
a spool for retracting the seatbelt, and a pretensioner for rotating the spool in a seatbelt retracting direction in an emergency, wherein the pretensioner comprises:
a pipe;
a plurality of force transmission members movably disposed in the pipe for transmitting a force for rotating a spool in a seatbelt retracting direction;
a gas generator which generates gas in the case of an emergency involving the vehicle;
a ring gear rotatably disposed, having plurality of internal teeth on an inner circumference and plural pressure receiving portions on an outer circumference; and
a pinion disposed on a spool side member, having external teeth meshed with the internal teeth for rotating the spool;
wherein the pretensioner is configured so that the force transmission member presses the pressure receiving portion of the ring gear to rotate the spool in the seatbelt retracting direction at a force transmission portion formed in the pipe in the emergency;
wherein the pretensioner is configured so that the force transmission member is movable through a movement path formed to have a circular shape concentric with a rotating center of the pinion; and
wherein one of the force transmission members may be located in the movement path at the end of an operation.
